(19) United States
(12) Patent Application Publication
(10) Pub. No.: US 2008/0044275 A1
(43) Pub. Date: Feb. 21, 2008

(54) PUMP

(75) Inventor: Toshiro Fujii, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/833,325

(22) Filed: Aug. 3, 2007

(30) Foreign Application Priority Data
Aug. 4, 2006 (JP) 2006-213041

(51) Int. Cl. F03B 11/08

(52) U.S. Cl. 415/121.2

(57) ABSTRACT

A hydrogen circulation pump including a liquid receptacle arranged in a discharge pipe extending upward from a housing or a discharge port arranged in the housing. The liquid receptacle extends along the entire circumference of the inner surface of the discharge pipe or the discharge port. Fine holes far circulating unreacted gas are formed in a bottom portion of the liquid receptacle. A water repellent film formed from a water repellent material is arranged on an upper surface of the bottom portion of the liquid receptacle.

### CROSS-REFERENCE TO RELATED APPLICATIONS

This application claims priority to Japanese Patent Application No. 2006-213041 filed Aug. 4, 2006.

### FIELD OF THE INVENTION

The present invention relates to a pump that discharges gas through a discharge pipe in which the gas is drawn into a pump chamber through a suction pipe by rotating a rotor accommodated in the pump chamber.

### BACKGROUND OF THE INVENTION

A fuel cell system for generating power from the reaction of hydrogen and oxygen includes a hydrogen circulation passage. Unreacted hydrogen gas that was not used by a fuel cell (unreacted gas) is re-supplied to the fuel cell through the hydrogen recirculation passage. A hydrogen circulation pump for transferring the unreacted gas is arranged in the hydrogen circulation passage.

For example, a Roots pump that is driven by a motor may be used as the hydrogen circulation pump. The Roots pump includes two rotors arranged in a pump chamber, which is defined in a housing. Each rotor is fixed to a rotation shaft. The Roots pump draws unreacted gas into the pump chamber through a suction pipe when the motor is driven to rotate the rotors. This discharges the unreacted gas, which is drawn into the pump chamber, out of the pump chamber through a discharge pipe. The unreacted gas transferred by the pump is mixed with fresh hydrogen gas supplied from the hydrogen tank and resupplied to the fuel cell.

In the fuel cell system, water, which is generated during the power generation, is discharged from the fuel cell together with the unreacted gas. The water and the unreacted gas is drawn into the pump chamber and then discharged out of the pump chamber. In this manner, water circulates together with the unreacted gas through the hydrogen circulation passage. Thus, when water is drawn into the pump chamber, the water may enter a space formed between the axial end surfaces of the rotors and the inner wall surface of the pump chamber (housing).

The water may freeze between the axial end surfaces of the rotors and the inner wall surface of the pump chamber when the fuel cell system is not operating in a low-temperature environment, such as in a subfreezing temperature environment. As a result, there is a possibility of the axial end surfaces of the rotors and the inner wall surface of the pump chamber cohering with each other or the two rotors cohering with each other. In such cases, a large torque is necessary to separate the rotors from the inner wall surface of the pump chamber when commencing operation of the fuel cell system. The Roots pump requires a large motor to produce such a large torque. This increases the size of the Roots pump.

To reduce the amount of water drawn into the pump chamber, for example, Japanese Laid-Open Patent Publication No. 2003-178782 proposes a hydrogen pump including a liquid storage unit arranged in a suction pipe and a discharge pipe. The suction pipe (suction portion) and the discharge pipe (discharge portion) of the hydrogen pump extend along a rotation shaft in a lower part of a housing. A set of liquid storage units is arranged in the lower part of the housing. The liquid storage units have downwardly extending recesses located at positions corresponding to the suction pipe and the discharge pipe. In this hydrogen pump, most of the water contained in the unreacted gas falls into the liquid storage units when the unreacted gas flows toward the pump chamber through the suction pipe. As a result, water is removed from the unreacted gas. This reduces the amount of water drawn into the pump chamber. Further, water contained in the unreacted gas falls into the liquid storage units when the unreacted gas flows through the discharge pipe after passing through the pump chamber. As a result, water is removed from the unreacted gas.

However, when the discharge pipe extends upward from the pump chamber, water contained in the unreacted gas collects on the inner surface of the discharge pipe. When the fuel cell system stops operating, the water moves along the inner surface of the discharge pipe and enters the pump chamber. Consequently, this pump has the same problem as the above-described pump in that when water freezes, the axial end surfaces of the rotors may cohere to the inner wall surface of the pump chamber.

### SUMMARY OF THE INVENTION

It is an object of the present invention to provide a pump that prevents liquid from entering a pump chamber from an upwardly extending discharge pipe.

One aspect of the present invention is a pump including a housing. A pump chamber is formed in the housing. A rotor is accommodated in the pump chamber. A suction pipe is connected to the pump chamber to draw gas into the pump chamber when the rotor is rotated. A discharge port is arranged in the housing in communication with the pump chamber to discharge the gas out of the pump chamber when the rotor is rotated. A discharge pipe is connected to the discharge port and extends upward from the discharge port. A liquid receptacle arranged in the discharge pipe or the discharge port receives liquid that falls along the inner surface of the discharge pipe. At least one circulation hole circulates the gas. A water falling prevention member is arranged on an upper surface of a bottom portion of the liquid receptacle to prevent the liquid from falling through the circulation hole.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of a hydrogen circulation pump;

FIG. 2 is a block diagram showing the structure of a fuel cell system;

FIG. 3 is a cross-sectional view showing the internal structure of a pump chamber;

FIG. 4 is an enlarged cross-sectional view of a liquid receptacle; and

FIG. 5 is an enlarged cross-sectional view of the liquid receptacle.

### DETAILED DESCRIPTION OF THE PREFERRED EMBODIMENTS

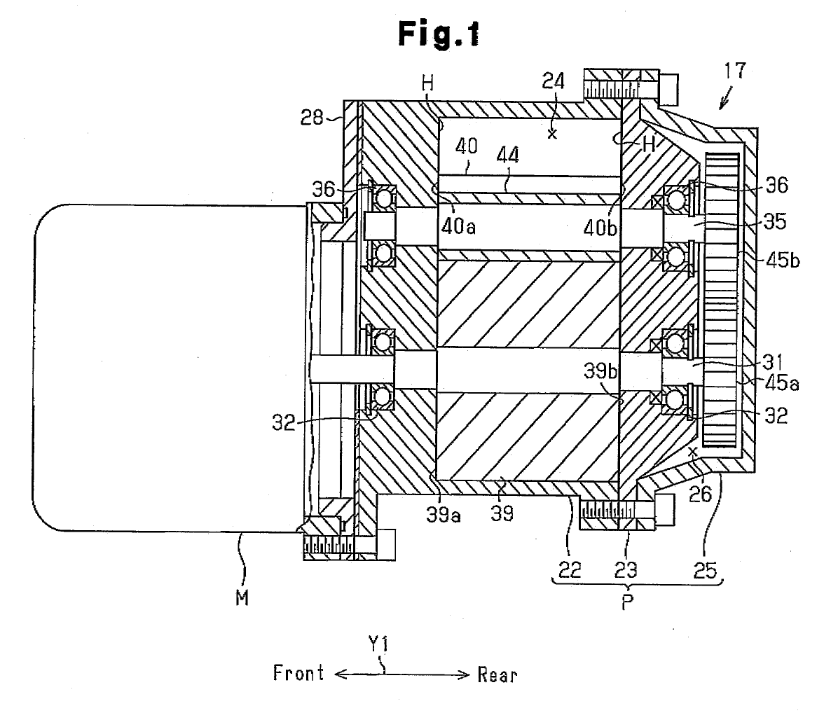

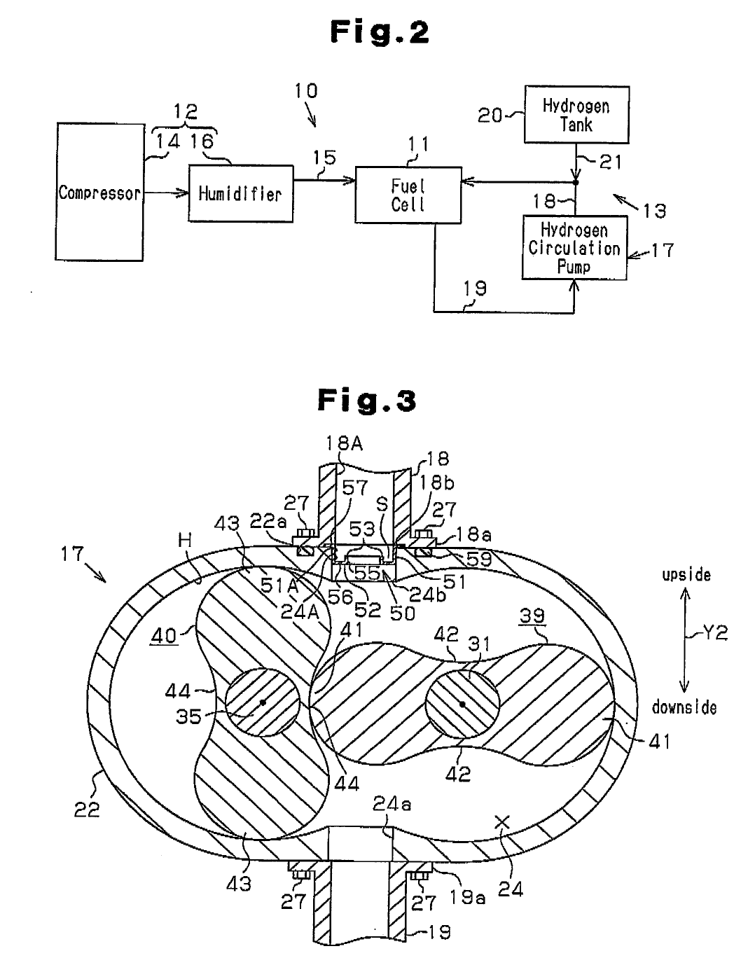

A hydrogen circulation pump of a fuel cell system according to a preferred embodiment of the present invention will now be described with reference to FIGS. 1 to 5. A fuel cell system 10 will be described first. As shown in FIG. 2, the fuel cell system 10 includes a fuel cell 11, an oxygen supply unit 12, and a hydrogen supply unit 13. The fuel cell 11 is a solid polymer fuel cell. The fuel cell 11 generates DC (direct current) electric energy (DC power) through the reaction of oxygen, which is supplied from the oxygen supply unit 12, and hydrogen, which is supplied from the hydrogen supply unit 13. The oxygen supply unit 12 includes a compressor 14 for supplying compressed air. The compressor 14 is connected to an oxygen supply port (not shown) of the fuel cell 11 through a duct 15. A humidifier 16 is arranged in the duct 15.

The hydrogen supply unit 13 includes a hydrogen circulation pump 17. The hydrogen circulation pump 17 is a Roots pump. The hydrogen circulation pump 17 circulates hydrogen gas that was not used in the fuel cell 11 (unreacted gas) and resupplies the unreacted gas to the fuel cell 11. The hydrogen circulation pump 17 is connected to a hydrogen supply port (not shown) of the fuel cell 11 through a discharge pipe 18 and to a hydrogen discharge port (not shown) of the fuel cell 11 through a suction pipe 19. The hydrogen supply unit 13 includes a hydrogen tank 20, which functions as a hydrogen source. The hydrogen tank 20 is connected to the discharge pipe 18 of the hydrogen circulation pump 17 through a duct 21. A regulator (not shown) is arranged in the duct 21. The hydrogen circulation pump 17, the discharge pipe 18, and the suction pipe 19 form a hydrogen circulation passage for circulating unreacted gas that was not used in the fuel cell 11 together with hydrogen gas supplied from the hydrogen tank 20 and supplying the unreacted gas to the fuel cell 11.

The hydrogen circulation pump 17 will now be described in detail. Hereafter, the frontward and rearward directions of the hydrogen circulation pump 17 are defined as indicated by an arrow Y1 in FIG. 1, and the upward and downward directions of the hydrogen circulation pump 17 are defined as indicated by an arrow Y2 in FIG. 3.

As shown in FIG. 1, the hydrogen circulation pump 17 includes a pump housing P and a motor housing M. The pump housing P is formed by joining a shaft support 23 with a rear end (right end in FIG. 1) of a rotor housing 22 and joining a gear housing 25 with a rear surface (right surface in FIG. 1) of the shaft support 23. A pump chamber 24 is formed between the rotor housing 22 and the shaft support 23. An inner surface of the rotor housing 22 and an inner surface of the shaft support 23 defines an inner wall surface H of the pump chamber 24.

A gear chamber 26 is formed between the gear housing 25 and the shaft support 23. The motor housing M is joined with a front end (left end in FIG. 1) of the rotor housing 22 by means of a partition wall 28. A motor chamber (not shown) is formed between the partition wall 28 and the motor housing M. The motor chamber accommodates an electric motor (not shown).

In the housing, a drive shaft 31 is rotatably supported in the motor housing M, the rotor housing 22, and the shaft support 23 by a bearing 32. A driven shaft 35 is rotatably supported in the rotor housing 22 and the shaft support 23 by a bearing 36. The driven shaft 35 extends parallel to the drive shaft 31.

As shown in FIGS. 1 and 3, in the pump chamber 24, a drive rotor 39, which functions as a rotor, is mounted on the drive shaft 31, and a driven rotor 40, which functions as a rotor, is mounted on the driven shaft 35. The drive shaft 31 is coaxial with the drive rotor 39. The driven shaft 35 is coaxial with the driven rotor 40.

As shown in FIG. 3, the cross-sections of the drive rotor 39 and the driven rotor 40 in a direction perpendicular to their axes have bi-lobed shapes. In other words, the rotors 39 and 40 are bi-lobed rotors. The drive rotor 39 has two teeth 41 and two valleys 42, which are arranged between the two teeth 41. The driven rotor 40 also has two teeth 43 and two valleys 44, which are arranged between the two teeth 43.

One of the teeth 41 of the drive rotor 39 engages one of the valleys 44 of the driven rotor 40 with a slight clearance formed therebetween. One of the teeth 43 of the driven rotor 40 engages one of the valleys 42 of the drive rotor 39 with a small clearance formed therebetween. The pump chamber 24 accommodates the drive rotor 39 and the driven rotor 40 in a manner that they are engageable with each other with a small clearance formed therebetween.

As shown in FIG. 1, a small clearance is formed between a front end surface 39aof the drive rotor 39 and the inner wall surface H of the pump chamber 24 and between a rear end surface 39b of the drive rotor 39 and the inner wall surface H of the pump chamber 24. Further, a small clearance (not shown) is formed between a front end surface 40a of the driven rotor 40 and the inner wall surface H of the pump chamber 24 and between a rear end surface 40b of the driven rotor 40 and the inner wall surface H of the pump chamber 24. These clearances prevent the end surfaces 39a and 39b of the drive rotor 39 and the inner wall surface H of the pump chamber 24 from contacting and seizing with each other and prevent the end surfaces 40a and 40b of the driven rotor 40 and the inner wall surface H of the pump chamber 24 from contacting and seizing with each other. The dimensions of the clearances are set to be just enough to prevent unreacted gas from leaking through the clearances.

As shown in FIG. 3, a lower part of the rotor housing 22 includes a suction port 24a. The suction pipe 19 is connected to the lower part of the rotor housing 22 in communication with the suction port 24a. The unreacted gas discharged from the fuel cell 11 is drawn into the pump chamber 24 through the suction pipe 19. A flange 19a is formed integrally with one end of the suction pipe 19. The flange 19a connects the suction pipe 19 to the rotor housing 22. In detail, the suction pipe 19 is connected to the rotor housing 22 by fastening bolts 27, which are inserted into holes formed in the flange 19a, with threaded holes formed in the rotor housing 22. Rotation of the drive rotor 39 and the driven rotor 40 draws unreacted gas into the pump chamber 24 through the suction pipe 19 and the suction port 24a.

A discharge port 24b is formed in an upper part of the rotor housing 22 at a position facing the suction port 24a. The discharge pipe 18 is connected to the upper part of the rotor housing 22 in communication with the discharge port 24b. The unreacted gas is discharged from the pump chamber 24 through the discharge pipe 18. A flange 18a is formed integrally with one end of the discharge pipe 18. The flange 18a connects the discharge pipe 18 to the rotor housing 22. In detail, the discharge pipe 18 is connected to the rotor housing 22 by fastening bolts 27, which are inserted into holes formed in the flange 18a, with the rotor housing 22. Rotation of the drive rotor 39 and the driven rotor 40 discharges unreacted gas out of the pump chamber 24 through the discharge port 24b and the discharge pipe 18.

As shown in FIG. 1, a drive gear 45a is fixed to one end of the drive shaft 31. A driven gear 45b is fixed to one end of the driven shaft 35. The drive gear 45a and the driven gear 45b are mated with each other in the gear chamber 26. When the electric motor is driven to rotate the drive shaft 31 of the hydrogen circulation pump 17, the produced torque is transmitted from the drive gear 45a to the driven gear 45b. At the same time, the mating of the gears 45a and 45b causes rotation of the driven shaft 35 in a direction opposite to the rotating direction of the drive shaft 31. This rotates the drive rotor 39 and the driven rotor 40 in the pump chamber 24.

The unreacted gas discharged from the fuel cell 11 is drawn into the pump chamber 24 through the suction port 24a from the suction pipe 19 as the drive rotor 39 and the driven rotor 40 rotate. Subsequently, the outer surfaces of the drive rotor 39 and the driven rotor 40 and the inner surface of the chamber 24 cooperate in the pump chamber 24 to transfer the unreacted gas to the discharge port 24b. The unreacted gas is discharged from the discharge port 24b into the discharge pipe 18. The unreacted gas discharged into the discharge pipe 18 is resupplied to the fuel cell 11 together with hydrogen gas supplied from the hydrogen tank 20.

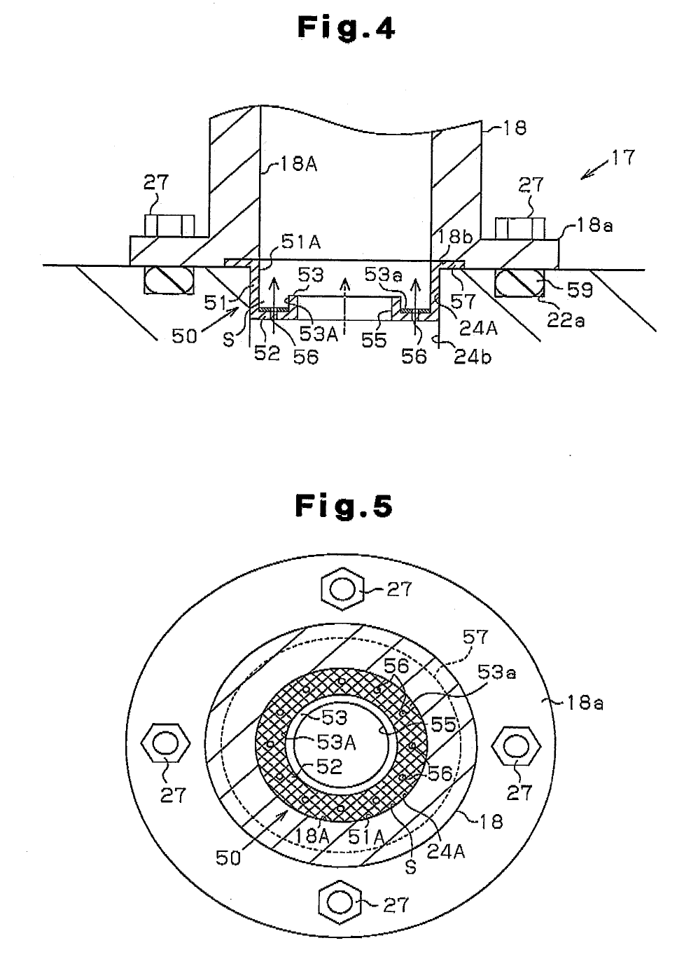

As shown in FIG. 4, a liquid receptacle 50 is arranged in the discharge part 24b. The liquid receptacle 50 receives water falling along an inner surface 18A of the discharge pipe 18. Water, which is generated when the fuel cell 11 generates power, is discharged from the fuel cell 11 together with the unreacted gas. The water is drawn into the pump chamber 24 with the unreacted gas when the hydrogen circulation pap 17 is driven. Then, the water and the unreacted gas axe discharged from the pump chamber 24.

The liquid receptacle 50 is arranged to extend over the entire circumference of an inner surface 24A of the discharge port 24b. The liquid receptacle 50 includes a cylindrical first wall portion 51, a bottom portion 52, and a cylindrical second wall portion 53. The first wall portion 51 is arranged an the inner surface 24A of the discharge port 24b. The bottom portion 52 extends inward from a lower end of the first wall portion 51. The second wall portion 53 extends upward from the bottom portion 52. The second wall portion 53 is arranged to face the first wall portion 51. The distance between the inner surface 51A of the first wall portion 51 and the inner surface 53A facing the first wall portion 51 of the second wall portion 53 is uniform. The liquid receptacle 50 has a storage space S for storing water. The storage space S is defined by a space farmed between the bottom portion 52, the first wall portion 51, and the second wall portion 53. The storage space S is annular when viewed from above.

A passage hole 55 extends through the center of the liquid receptacle 50. Unreacted gas passes through the passage hole 55 and is discharged from the pump chamber 24 into the discharge pipe 18. The inner surface 51A of the first wall portion 51 and the inner surface 18A of the discharge pipe 18 have the same diameter. The diameter of the discharge port 24b is greater than the inner diameter of the discharge pipe 18 by a value corresponding to the thickness of the first wall portion 51. As a result, the inner surface 18A of the discharge pipe 18 is flush with the inner surface 51A of the first wall portion 51 in a state in which the liquid receptacle 50 is arranged in the discharge port 24b.

As shown in FIG. 5, a plurality of fine holes 56, which function as circulation holes, are formed in the bottom portion 52 of the liquid receptacle 50. The fine holes 56 are arranged at regular intervals along the peripheral part of the bottom portion 52. Unreacted gas (discharge gas) discharged from the pump chamber 24 and flowing toward the fuel cell 11 passes through the fine holes 56 of the liquid receptacle 50. As shown by the hatched section in FIG. 5, a water falling prevention member for preventing water from falling through the fine holes 56 is arranged on the upper surface of the bottom portion 52 avoiding the fine holes 56. The water falling prevention member is formed by a water repellent film 53a. The water repellent film 53a repels water on the upper surface of the bottom portion 52 so as to form water droplets on the upper surface of the bottom portion 52. This prevents water from falling through the fine holes 56. The water repellent film 53a is formed by coating the upper surface of the bottom portion 52 with fluorine resin.

As shown in FIGS. 4 and 5, a flange 57 is formed integrally with an upper end of the first wall portion 51 of the liquid receptacle 50. The flange 57, which is arranged over the entire circumference of the first wall portion 51, extends horizontally from the upper end of the first wall portion 51. The flange 57 is placed on the upper surface of the rotor housing 22 around the discharge port 24b when the liquid receptacle 50 is arranged in the discharge port 24b. The flange 57 positions the liquid receptacle 50 in the discharge port 24b.

An annular groove 22a extends along the upper surface of the rotor housing 22 around the upper opening of the discharge port 24b. An O-ring 59 is received in the annular groove 22a. Further, a recess 18b, which is continuous with the inner surface 18A of the discharge pipe 18, is formed in the lower surface of the flange 18a of the discharge pipe 18.

When fastening the discharge pipe 18 to the rotor housing 22 with the bolts 27, the flange 57 placed on the portion around the discharge port 24b is accommodated in the recess 18b arranged in the lower surface of the discharge pipe 18. By accommodating the flange 57 in the recess 18b, the lower surface of the flange 18a, excluding the portion corresponding to the recess 18b, comes in contact with the upper surface of the rotor housing 22. As a result, the lower surface of the flange 18a is pressed against the O-ring 59. This prevents the leakage of unreacted gas from between the discharge pipe 18 and the rotor housing 22.

When the fuel cell system 10 and the hydrogen circulation pump 17 are both driven, unreacted gas containing water is discharged from the fuel cell 11 and then drawn into the pump chamber 24 through the suction port 24a from the suction pipe 19 and ultimately discharged through the discharge port 24b into the discharge pipe 18. This causes the water contained in the unreacted gas to collect on the inner surface 18A of the discharge pipe 18 and the inner surface of the suction pipe 19. When the hydrogen circulation pump 17 is driven, the unreacted gas discharged from the pump chamber 24 flows upward through the discharge pipe 18 and prevents the water on the inner surface 18A of the discharge pipe 18 from entering the pump chamber 24.

When the fuel cell system 10 and the hydrogen circulation pump 17 stop operating, the drive rotor 39 and the driven rotor 40 also stop rotating. As a result, gravitational force causes the water collected on the inner surface 18A of the discharge pipe 18 to fall along the inner surface 18A. In the present embodiment, the liquid receptacle 50 extends along the entire circumference of the inner surface 24A of the discharge part 24b, and the inner surface 51A of the liquid receptacle 50 is continuous with the inner surface 18A of the discharge pipe 18. Thus, the water on the inner surface 18A of the discharge pipe 18 falls along the inner surface 51A of the wall portion 51 and onto the bottom portion 52. As a result, the water is received in the storage space S. This prevents the water falling along the inner surface 18A of the discharge pipe 18 from entering the pump chamber 24.

The water repellent film 53a on the bottom portion 52 prevents the water from spreading and repels the water so as to form water droplets on the bottom portion 52. The water droplets gather and form larger droplets. This prevents the water from falling through the fine holes 56. Accordingly, the water on the inner surface 18A of the discharge pipe 18 is further effectively prevented from flowing into the pump chamber 24.

When the fuel cell system 10 starts operating, the unreacted gas discharged from the pump chamber 24 flows upward from the discharge port 24b through the large number of fine holes 56. The unreacted gas flowing through the fine holes 56 blows away the water droplets from the fine holes 56 in an upward direction. This prevents the water droplets from continuing to remain in the fine holes 56. This structure further effectively prevents the water on the inner surface 18A of the discharge pipe 18 from entering the pump chamber 24 when the fuel cell system 10 is operating or stops operating.

The above embodiment has the advantages described below.

(1) The liquid receptacle 50 is arranged to extend along the entire circumference of the inner surface 24A of the discharge port 24b in the discharge pipe, which extends upward from the pump chamber 24. Water falling along the inner surface 18A of the discharge pipe 18 is received by the liquid receptacle 50. This prevents the water in the discharge pipe 18 from flowing into the pump chamber 24. Further, the water repellent film 53a arranged on the upper surface of the bottom portion 52 prevents the water from spreading on the bottom portion 52 and repels the water so as to form water droplets. The water droplets gather to form droplets having a larger diameter than the diameter of the fine holes 56. This prevents the water from falling through the fine holes 56. Further, the plurality of fine holes 56 are formed in the bottom portion 52 of the liquid receptacle 50. In this case, the unreacted gas flowing through the fine holes 56 blows away the water collected in the bottom portion 52 or in the fine holes 56 of the liquid receptacle 50.

Thus, when the hydrogen circulation pump 17 is operating or stops operating, the water on the inner surface 18A of the discharge pipe 18 does not enter the pump chamber 24. Further, water is prevented from entering the space between the end surfaces 39a and 39b of the drive rotor 39 and the inner wall surface H of the pump chamber 24 and the space between the end surfaces 40a and 40b of the driven rotor 40 and the inner wall surface H of the pump chamber 24. Therefore, there is no water that freezes between the end surfaces 39a and 39b of the drive rotor 39 or the end surfaces 40a and 40b of the driven rotor 40 and the inner wall surface H of the pump chamber 24 in a low-temperature environment (subfreezing temperature). This prevents the end surfaces 39a and 39b of the drive rotor 39 or the end surfaces 40a and 40b of the driven rotor 40 and the inner wall surface H of the pump chamber 24 from cohering together. Thus, when the fuel cell system 10 commences operation, a large torque is unnecessary to separate the rotors 39 and 40 from the inner wall surface H of the pump chamber 24. This avoids the need for enlargement of the hydrogen circulation pump 17 since a large electric motor would not be necessary.

(2) The liquid receptacle 50 is arranged in the discharge port 24b, that is, in the portion of the discharge pipe below the discharge pipe 18. Thus, the water on the inner surface 18A of the discharge pipe 18 is received by the liquid receptacle 50, which is arranged immediately before the pump chamber 24. Fox example, if the liquid receptacle 50 were to be arranged in the discharge pipe 18 above the discharge port 24b, the water on the wall surface of the discharge pipe below the liquid receptacle 50 may enter the pump chamber 24. The arrangement of the liquid receptacle 50 in the discharge port 24b prevents the water falling along the inner surface 18A of the discharge pipe 18 Pram entering the pump chamber 24.

(3) The flange 57 is farmed integrally with the liquid receptacle 50. The flange 57 is placed on the upper surface of the rotor housing 22 around the discharge port 24b and held between the flange 18a of the discharge pipe 18 and the rotor housing 22. This positions the liquid receptacle 50 in the discharge port 24b. Accordingly, the liquid receptacle 50 is easily positioned as compared with when the liquid receptacle 50 is integrally formed with the inner surface 18A of the discharge pipe 18 or the inner surface 24A of the discharge port 24b.

(4) The fuel cell system 10, which includes the hydrogen circulation passage and the hydrogen circulation pump 17, generates water through reaction of hydrogen and oxygen, and the water collects on the inner surface 18A of the discharge pipe 18. In the present embodiment, the liquid receptacle 50 is arranged in the discharge pipe of the hydrogen circulation pump 17. The liquid receptacle 50 prevents the water that falls in the discharge pipe from entering the pump chamber 24. This reduces the amount of water entering the pump chamber 24. Thus, the liquid receptacle 50 is particularly meritorious for the hydrogen circulation pump 17, which supplies unreacted gas to the fuel cell 11 through the hydrogen circulation passage.

It should be apparent to those skilled in the art that the present invention may be embodied in many other specific forms without departing from the spirit or scope of the invention. Particularly, it should be understood that the present invention may be embodied in the following forms.

In the present embodiment, the fine holes 56 may be covered by a porous film made of polytetrafluoroethylene (PTFE), such as Gore Tex (registered trademark). The porous film does not allow the passage of water but allows the passage of unreacted gas. Thus, the porous film prevents water from falling through the fine holes 56 and enables the water to be blown away by the unreacted gas.

Only a single fine hole 56 may be formed in the bottom portion 52.

The liquid receptacle 50 may be arranged on the inner surface 18A of the discharge pipe 18 above the discharge port 24b.

The liquid receptacle 50 may be made of stainless steel. In this case, the stainless steel is water repellent and prevents the water that falls on the bottom portion 52 from spreading and forms water droplets. In other words, the liquid receptacle 50 functions as a water falling prevention member for preventing water from falling through the fine holes 56.

The water repellent film 53a may be arranged only around the fine holes 56. The water repellent film 53a does not necessarily have to be arranged on the entire upper surface of the bottom portion 52 as long as the water repellent film 53a prevents the water that falls on the bottom portion 52 from entering the fine holes 56.

The fine holes 56 may be formed to extend through the second wall portion 53 in the transversal direction near the bottom portion 52. More specifically, the fine holes 56 do not have to be formed in the bottom portion 52 and may be formed at any position as long as the fine holes 56 allow the passage of unreacted gas so that the water in the liquid receptacle 50 can be blown away by the unreacted gas.

The inner surface 18A of the discharge pipe 18 and the inner surface 51A of the wall portion 51 of the liquid receptacle 50 do not have to be continuous.

In addition to the liquid receptacle 50 arranged in the discharge port 24b, a further liquid receptacle 50 may be arranged in the discharge pipe 18.

The liquid receptacle 50 may be formed integrally with the inner surface 24A of the discharge port 24b or the inner surface 18A of the discharge pipe 18.

Instead of the bi-lobed cross-section, the drive rotor 39 and the driven rotor 40 may each have a cross-section that includes any number of lobes.

The hydrogen circulation pump 17 may be a multistage hydrogen circulation pump including a plurality of drive rotors 39 and driven rotors 40 mounted on the corresponding drive shaft 31 and driven shaft 35.

The pump may be a screw pump including a screw rotor.

The present examples and embodiments are to be considered as illustrative and not restrictive, and the invention is not to be limited to the details given herein, but may be modified within the scope and equivalence of the appended claims.

What is claimed:

1. A pump comprising:
a housing;
a pump chamber formed in the housing;
a rotor accommodated in the pump chamber;
a suction pipe connected to the pump chamber to draw gas into the pump chamber when the rotor is rotated;
a discharge port arranged in the housing in communication with the pump chamber to discharge the gas out of the pump chamber when the rotor is rotated;
a discharge pipe connected to the discharge port and extending upward from the discharge port;
a liquid receptacle, arranged in the discharge pipe or the discharge port, for receiving liquid that falls along the inner surface of the discharge pipe, the liquid receptacle extending along the entire circumference of the inner surface of the discharge pipe or the discharge port;
at least one circulation hale for circulating the gas; and
a water falling prevention member arranged on the liquid receptacle to prevent the liquid from falling through the circulation hole.

2. The pump according to claim 1, wherein the liquid receptacle includes a flange formed integrally with the liquid receptacle and extending outward from an upper end of the liquid receptacle, with the housing and the discharge pipe holding the flange around the discharge part and positioning the liquid receptacle in the discharge port.

3. The pump according to claim 1, wherein the liquid receptacle includes a plurality of circulation holes arranged along a peripheral portion of the liquid receptacle.

4. The pump according to claim 1, wherein the water falling prevention member is water repellent and arranged on the bottom portion of the liquid receptacle.

5. The pump according to claim 1, wherein the water falling prevention member is formed from a porous resin film that covers the circulation holes.

6. The pump according to claim 1, wherein the pump is a hydrogen circulation pump for use with a fuel cell system and supplies hydrogen gas supplied from a hydrogen source and hydrogen unused by a fuel cell to the fuel cell, wherein the hydrogen circulation pump draws the hydrogen gas unused by the fuel cell into the pump chamber through the suction pipe and discharges the hydrogen gas out of the pump chamber through the discharge pipe and to the fuel cell.
